(19) United States
(12) Patent Application Publication
(10) Pub. No.: US 2014/0088951 A1
(43) Pub. Date: Mar. 27, 2014

(54) TRANSLATING DIGITAL RECEIPTS BETWEEN WRITTEN LANGUAGES

(71) Applicant: Wal-Mart Stores, Inc., Bentonville, AR (US)

(72) Inventors: Stuart Argue, Palo Alto, CA (US); Anthony Emile Marcar, San Francisco, CA (US)

(21) Appl. No.: 13/629,421

(22) Filed: Sep. 27, 2012

(51) Int. Cl. G06F 17/28

(52) U.S. Cl. CPC G06F 17/289
USPC 704/2

(57) ABSTRACT

The present invention extends to methods, systems, and computer program products for translating digital receipts between written languages. In response to a user request, digital receipts (e.g., for retail sales transactions) can be translated from a first written language to a second written language. Translated digital receipts can be presented on a display at a mobile device. Translation can be handled at a receipt data server or at the mobile device. Translation can be performed locally or can be referred to a translation server. Digital receipts can be translated from and/or to any of a variety of different written languages.

### BACKGROUND

1. Field of the Invention

This invention relates generally to the field of electronic sales transactions, and, more particularly, to translating digital receipts between written languages.

2. Related Art

In a variety of transactions, consumers or buyers of goods or services typically receive receipts from their respective merchants or service providers as proof of existence of conducted transactions. Generally, receipts are issued by merchants and service providers for a number of reasons including, for example, regulatory or tax reasons and convenience purposes. A receipt provides information about a corresponding transaction for the purpose of providing all participants with a trace or record of the transaction. Receipts can later be used by a consumer for various purposes including, for example, proving participation in a transaction for tax reporting purpose, product returns, use as a claim ticket for a further transaction, provisioning warranties, etc. For in-store purchases, consumers generally obtain a paper receipt at the point-of-sale. Accordingly, consumers frequently retain paper receipts for some amount of time after a transaction. Saved paper receipts can then be used by consumers later to return merchandise, to track expenses for budgeting purposes, or to substantiate tax, reimbursement, or warranty claims, among many other uses.

In many situations, it may be desirable to obtain a version of a receipt in a written language other than the written language in which the receipt was originally generated. For example, if a purchase is made in a country that uses a written language other than a customer's native written language, the customer may have limited, if any, understanding of the contents of the receipt.

Alternately, even if a customer can understand the written language used to generate a receipt, other person's associated with a transaction may desire to view the receipt. These other persons may not be proficient in the written language. Many households include family members with varied proficiency in different written languages. For example, a household can include children that are proficient in a written language and parents that are proficient in another different written language. Thus, if a child receives a receipt in the written language, the parents may not be able to fully understand the contents of the receipt. However, the parents may have a desire to know what their child has purchased.

### BRIEF DESCRIPTION OF THE DRAWINGS

The specific features, aspects and advantages of the present invention will become better understood with regard to the following description and accompanying drawings where:

FIG. 1 illustrates an example block diagram of a computing device.

FIG. 2 illustrates an example computer architecture that facilitates translating digital receipts between written languages.

FIG. 3 illustrates a flow chart of an example method for translating digital receipts between written languages.

FIG. 4 illustrates another computer architecture that facilitates translating digital receipts between written languages.

FIG. 5 illustrates another flow chart of an example method for translating digital receipts between written languages.

FIG. 6 illustrates an example schematic block diagram of a point-of-sale (“POS”) system.

FIG. 7 illustrates an example schematic block diagram of a network of point-of-sale (“POS”) systems.

### DETAILED DESCRIPTION

The present invention extends to methods, systems, and computer program products for translating digital receipts between written languages. In the following description of the present invention, reference is made to the accompanying drawings, which form a part hereof, and in which is shown by way of illustration specific embodiments in which the invention is may be practiced. It is understood that other embodiments may be utilized and structural changes may be made without departing from the scope of the present invention.

Embodiments of the present invention may comprise or utilize a special purpose or general-purpose computer including computer hardware, such as, for example, one or more processors and system memory, as discussed in greater detail below. Embodiments within the scope of the present invention also include physical and other computer-readable media for carrying or storing computer-executable instructions and/or data structures. Such computer-readable media can be any available media that can be accessed by a general purpose or special purpose computer system. Computer-readable media that store computer-executable instructions are computer storage media (devices). Computer-readable media that carry computer-executable instructions are transmission media. Thus, by way of example, and not limitation, embodiments of the invention can comprise at least two distinctly different kinds of computer-readable media: computer storage media (devices) and transmission media.

Computer storage media (devices) includes RAM, ROM, EEPROM, CD-ROM, solid state drives (“SSDs”) (e.g., based on RAM), Flash memory, phase-change memory (“PCM”), other types of memory, other optical disk storage, magnetic disk storage or other magnetic storage devices, or any other medium which can be used to store desired program code means in the form of computer-executable instructions or data structures and which can be accessed by a general purpose or special purpose computer.

A “network” is defined as one or more data links that enable the transport of electronic data between computer systems and/or modules and/or other electronic devices. When information is transferred or provided over a network or another communications connection (either hardwired, wireless, or a combination of hardwired or wireless) to a computer, the computer properly views the connection as a transmission medium. Transmissions media can include a network and/or data links which can be used to carry desired program code means in the form of computer-executable instructions or data structures and which can be accessed by a general purpose or special purpose computer. Combinations of the above should also be included within the scope of computer-readable media.

Further, upon reaching various computer system components, program code means in the form of computer-executable instructions or data structures can be transferred automatically from transmission media to computer storage media (devices) (or vice versa). For example, computer-executable instructions or data structures received over a network or data link can be buffered in RAM within a network interface module (e.g., a “NIC”), and then eventually transferred to computer system RAM and/or to less volatile computer storage media (devices) at a computer system. RAM can also include solid state drives (SSDs or PCIx based real time memory tiered Storage, such as FusionIO). Thus, it should be understood that computer storage media (devices) can be included in computer system components that also (or even primarily) utilize transmission media.

Computer-executable instructions comprise, for example, instructions and data which, when executed at a processor, cause a general purpose computer, special purpose computer, or special purpose processing device to perform a certain function or group of functions. The computer executable instructions may be, for example, binaries, intermediate format instructions such as assembly language, or even source code. Although the subject matter has been described in language specific to structural features and/or methodological acts, it is to be understood that the subject matter defined in the appended claims is not necessarily limited to the described features or acts described above. Rather, the described features and acts are disclosed as example forms of implementing the claims.

Those skilled in the art will appreciate that the invention may be practiced in network computing environments with many types of computer system configurations, including, personal computers, desktop computers, laptop computers, message processors, hand-held devices, multi-processor systems, microprocessor-based or programmable consumer electronics, network PCs, minicomputers, mainframe computers, mobile telephones, PDAs, tablets, pagers, routers, switches, various storage devices, and the like. The invention may also be practiced in distributed system environments where local and remote computer systems, which are linked (either by hardwired data links, wireless data links, or by a combination of hardwired and wireless data links) through a network, both perform tasks. In a distributed system environment, program modules may be located in both local and remote memory storage devices.

Embodiments of the invention can also be implemented in cloud computing environments. In this description and the following claims, “cloud computing” is defined as a model for enabling ubiquitous, convenient, on-demand network access to a shared pool of configurable computing resources (e.g., networks, servers, storage, applications, and services) that can be rapidly provisioned via virtualization and released with minimal management effort or service provider interaction, and then scaled accordingly. A cloud model can be composed of various characteristics (e.g., on-demand self-service, broad network access, resource pooling, rapid elasticity, measured service, etc.), service models (e.g., Software as a Service (SaaS), Platform as a Service (PaaS), Infrastructure as a Service (IaaS), and deployment models (e.g., private cloud, community cloud, public cloud, hybrid cloud, etc.). Databases and servers described with respect to the present invention can be included in a cloud model.

It is further noted that, where feasible, functions described herein can be performed in one or more of: hardware, software, firmware, digital components, or analog components. For example, one or more application specific integrated circuits (ASICs) can be programmed to carry out one or more of the systems and procedures described herein. Certain terms are used throughout the following description and Claims to refer to particular system components. As one skilled in the art will appreciate, components may be referred to by different names. This document does not intend to distinguish between components that differ in name, but not function.

In this description and in the following claims, an “application ID” is defined as an identifier used to match a mobile device to a sales transaction. An application ID can be a receipt ID, an account ID, a session ID, a user name, an application specific ID, an ID from a device keychain, any other token as well as a combination of one of more of these. In some embodiments, a receipt ID for a digital receipt is contained in a QR code in a corresponding paper receipt. A mobile device can scan the QR code to obtain the receipt ID. The mobile device can then use the receipt ID to request the digital receipt from a receipt data server.

In general, embodiments of the invention are directed to translating digital receipts between written languages. A point-of-sale (“POS”) system generates digital receipt data as part of a sales transaction for a customer. The point-of-sale (“POS”) system transfers an application identifier for the customer's mobile device along digital receipt data for the sales transaction to a receipt data server. The receipt data server formulates a digital receipt in a first written language from the digital receipt data. The receipt data server stores the application identifier along with the digital receipt.

Subsequently, the customer (or another user) can use the mobile device to request digital receipts from the receipt data server. The mobile device can request receipts in the first written language. Alternately, the mobile device can request receipts in a second different written language. In some embodiments, a written language is specified at the time receipts are requested. In other embodiments, a written language is stored in configuration settings, for example, at the mobile device and/or at the receipt data server. The configuration settings can be referred to when a request for receipts is received.

When digital receipts are requested in a second different written language, the receipt data server can handle translating digital receipts from the first written language to the second different written language. In some embodiments, the receipt data server has a translation module that can be used to translate digital receipts from the first written language to the second written language locally. The receipt data server the returns the digital receipts in the second written language to the mobile device. The receipt data server can also store the digital receipts in the second written language for later access.

In other embodiments, the receipt data server sends digital receipts in the first written language to a translation server for translation. The translation server translates the digital receipts from the first written language to the second written language. The translation server returns digital receipts in the second written language to the receipt data server. The receipt data server receives the digital receipts in the second written language from the translation server. The receipt data server can then send the digital receipts in the second written language to the mobile device. The receipt data server can also store the digital receipts in the second written language for later access. In some embodiments, the translation server returns digital receipts in the second written language directly to the mobile device. The mobile device can receive digital receipts in the second written language and present digital receipts for viewing by a user in the second written language.

In some embodiments, a mobile device requests digital receipts in a first written language and then the mobile device handles translating the digital receipts into the second written language. For example, a mobile device can send digital receipts in the first written language to a translation server for translation. The translation server translates the digital receipts from the first written language to the second written language. The translation server returns digital receipts in the second written language to the mobile device. The mobile device can receive digital receipts in the second written language and present digital receipts for viewing by a user in the second written language.

In other embodiments, the mobile device has a translation module that can be used to translate digital receipts from the first written language to the second written language locally. The mobile device can receive digital receipts in the first written language (e.g., from a data receipt server), translate the digital receipts from the first written language to the second written language, and present digital receipts for viewing by a user in the second written language.

Translating a digital receipt between written languages can include translating some or all of the written text contained in the digital receipt. For example, translation can include translating item descriptions and any additional descriptive text (e.g., surveys, advertisements, etc.).

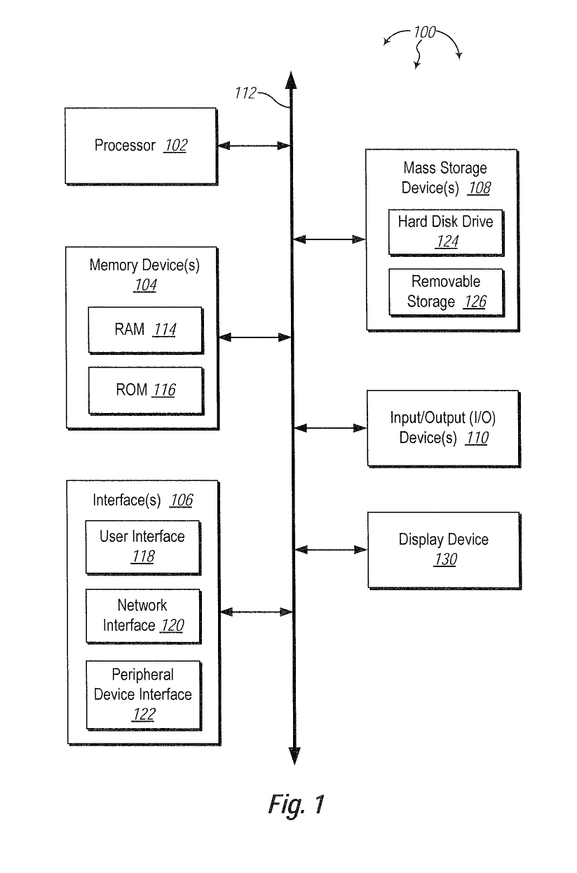

FIG. 1 illustrates an example block diagram of a computing device 100. Computing device 100 can be used to perform various procedures, such as those discussed herein. Computing device 100 can function as a server, a client, or any other computing entity. Computing device 100 can perform various communication and data transfer functions as described herein and can execute one or more application programs, such as the application programs described herein. Computing device 100 can be any of a wide variety of computing devices, such as a mobile telephone or other mobile device, a desktop computer, a notebook computer, a server computer, a handheld computer, tablet computer and the like.

Computing device 100 includes one or more processor(s) 102, one or more memory device(s) 104, one or more interface(s) 106, one or more mass storage device(s) 108, one or more Input/Output (I/O) device(s) 110, and a display device 130 all of which are coupled to a bus 112. Processor(s) 102 include one or more processors or controllers that execute instructions stored in memory device(s) 104 and/or mass storage device(s) 108. Processor(s) 102 may also include various types of computer storage media, such as cache memory.

Memory device(s) 104 include various computer storage media, such as volatile memory (e.g., random access memory (RAM) 114) and/or nonvolatile memory (e.g., read-only memory (ROM) 116). Memory device(s) 104 may also include rewritable ROM, such as Flash memory.

Mass storage device(s) 108 include various computer storage media, such as magnetic tapes, magnetic disks, optical disks, solid state memory (e.g., Flash memory), and so forth. As depicted in FIG. 1, a particular mass storage device is a hard disk drive 124. Various drives may also be included in mass storage device(s) 108 to enable reading from and/or writing to the various computer readable media. Mass storage device(s) 108 include removable media 126 and/or non-removable media.

I/O device(s) 110 include various devices that allow data and/or other information to be input to or retrieved from computing device 100. Example I/O device(s) 110 include cursor control devices, keyboards, keypads, barcode scanners, microphones, monitors or other display devices, speakers, printers, network interface cards, modems, cameras, lenses, CCDs or other image capture devices, and the like.

Display device 130 includes any type of device capable of displaying information to one or more users of computing device 100. Examples of display device 130 include a monitor, display terminal, video projection device, and the like.

Interface(s) 106 include various interfaces that allow computing device 100 to interact with other systems, devices, or computing environments as well as humans. Example interface(s) 106 can include any number of different network interfaces 120, such as interfaces to personal area networks (PANs), local area networks (LANs), wide area networks (WANs), wireless networks (e.g., near field communication (NFC), Bluetooth, Wi-Fi, etc, networks), and the Internet. Other interfaces include user interface 118 and peripheral device interface 122.

Bus 112 allows processor(s) 102, memory device(s) 104, interface(s) 106, mass storage device(s) 108, and I/O device(s) 110 to communicate with one another, as well as other devices or components coupled to bus 112. Bus 112 represents one or more of several types of bus structures, such as a system bus, PCI bus, IEEE 1394 bus, USB bus, and so forth.

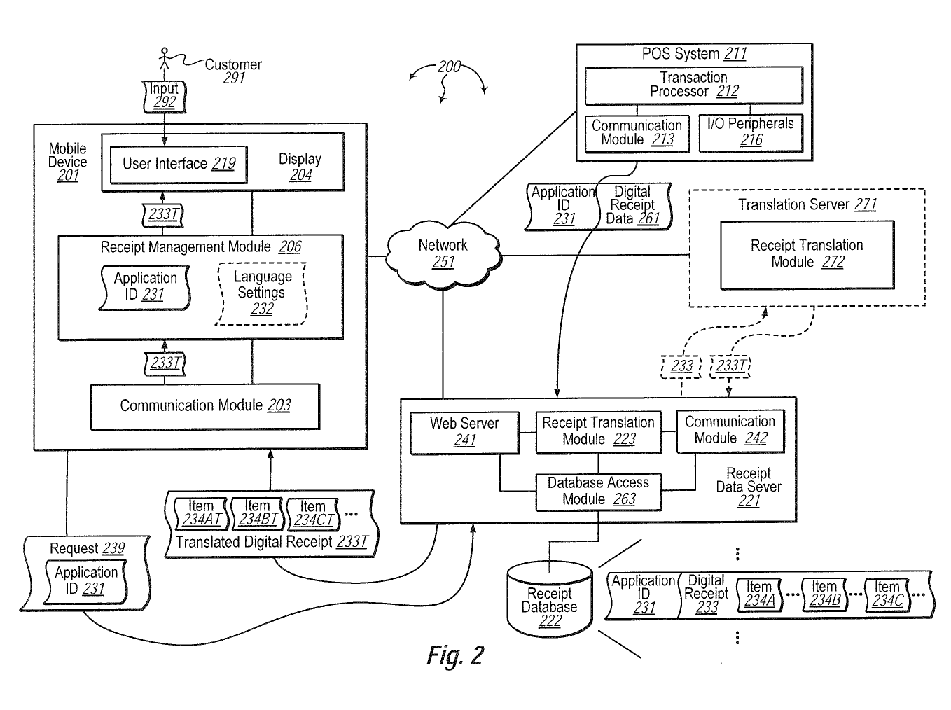

FIG. 2 illustrates an example computer architecture 200 that facilitates translating digital receipts between written languages. Referring to FIG. 2, computer architecture 200 includes mobile device 201, POS system 211, receipt data server 221, and translation server 271. Each of the depicted systems, servers, and devices as well as their respective components can be connected to one another over (or be part of) network 251, such as, for example, a PAN, a LAN, a WAN, and even the Internet. Accordingly, each of the depicted components as well as any other connected computer systems and their components, can create message related data and exchange message related data (e.g., near field communication (NFC) payloads, Bluetooth packets, Internet Protocol (IP) datagrams and other higher layer protocols that utilize IP datagrams, such as, Transmission Control Protocol (TCP), Hypertext Transfer Protocol (HTTP), Simple Mail Transfer Protocol (SMTP), etc.) over the network.

POS system 211 includes transaction processor 212, communication module 213, and I/O peripherals 216. POS system 211 can be physically located at a checkout lane in a store. Generally, transaction processor 212 is configured to manage sales transactions for POS 211. Transaction processor 212 can receive input from I/O peripherals 216 to open a sales transaction, collect receipt data (e.g., date, time, item, number of units, cost data, tax, department, etc.) for a sales transaction, and close a sales transaction. Receipt data for an item (e.g. item description, item cost, department, etc.) can be retrieved from an item database in response to scanning a barcode on (or otherwise identifying) the item. Other receipt data for an item (e.g., number of units, tax, etc.) can be calculated by transaction processor 212. I/O peripherals 216 can include one or more of: a monitor (e.g., a cashier-facing monitor), one or more input devices (e.g., scanners, keyboards, scales, or the like), one or more payment devices (e.g., cash drawers, card readers, etc.) for receiving or returning payments, and one or more output devices (e.g., customer-facing display or monitor, receipt printer, etc.).

Communication module 213 can be a wired and/or wireless network adapter for connecting POS system 211 with a network, such as, for example, a Wi-Fi and/or wired Ethernet network, that facilitates a further connection to network 251 (e.g., the Internet).

POS system 211 can be at a physical store location along with additional POS systems including similar components. The physical store location may be owned by an entity, such as, for example, a retailer corporation that runs a chain of stores. The chain of stores can include one or more of: grocery stores, department stores, warehouse stores, discount stores, etc. In some embodiments, POS system 211 includes components in a checkout isle as well as components in a store based data center. Other POS systems, also including similar components, can be at other physical store locations owned by the entity.

Receipt data server 221 includes receipt translation module 223, Web server 241, communication module 242, and database access module 263. Web server 241 is configured to communicate with external devices, such as, for example, mobile device 201. A common entity, such as, a retailer corporation, can own one or more physical store locations (e.g., a chain of stores) as well as receipt data server 221. Each of the one or more store physical locations can include one or more POS systems as well as other computer systems (e.g., local backend servers). Communication module 242 can be configured to communicate with POS systems as well as other computer systems at each of the one or more physical store locations (e.g., on an internal corporate network) to facilitate business operations for the entity.

Receipt data server 221 can receive application identifiers and digital receipt data from POS systems at various different store locations, including POS system 211. Receipt data server 221 can formulate digital receipts from received receipt data. Formulated digital receipts can include entries for items included in corresponding digital receipt data (but potentially in a different format, for example, a format deliverable to mobile devices). Database access module 263 can store digital receipts along with application identifiers in receipt database 222. The application identifiers map digital receipts to corresponding mobile devices. Application identifiers can be indicated, either manually by a customer in an automated fashion by a mobile device, at the time of a transaction.

For example, receipt data server 221 can receive application ID 231 along with digital receipt data 261 from POS system 211. Receipt data server 221 can formulate digital receipt 233 from digital receipt data 261. Digital receipt 233 includes receipt entries for items 234A, 234B, 234C, etc. Receipt items 244A, 244B, 234C, etc. correspond to physical items purchased during a transaction at POS system 211. Digital receipt 233 can be stored along with application ID 231 to indicate that digital receipt 233 corresponds to mobile device 201.

In some embodiments, receipt data server 221 is part of a (e.g., regional, national, or global) backend system that receives receipt data from a plurality of POS systems distributed throughout different geographic locations and formulates corresponding digital receipts. The plurality of POS systems and the backend system can be part of a commonly owned and/or controlled corporate network infrastructure.

Subsequent to storing digital receipts, receipt data server 221 can send stored digital receipts to customer computing devices, such as, for example, smartphones and/or tablets. Receipt data server 221 can send digital receipts to a mobile device in response to a request and/or in accordance with configured settings. For example, in response to a request for receipts from mobile device 201, receipt data server 221 can send digital receipt 233 to mobile device 201. Sending digital receipts from receipt data server 221 to a mobile device can involve push or polled mechanisms. Receipt data server 221 can send digital receipts in a web or native view.

When appropriate, translation module 223 can translate a digital receipt from one written language to another written language. Translation module 223 can be configured to translate digital receipt from and/or to virtually any written language, including but not limited to: written languages that use variations of the Latin alphabet (e.g., written languages that use the English alphabet, the German Alphabet, the Czech alphabet, etc.), written languages that use variations of Cryllic script (e.g., written languages that use the Russian alphabet, etc.), written languages that use variations of Arabic script, Greek, written languages that use the Hebrew alphabet, written languages that use Chinese script (hanzi) (e.g., Mandarin), written languages that use Japanese script (kanji, hiragana, katakana), Korean, written languages that use the Devanagari alphabet (e.g., Hindi) as well as written languages that use characters or symbols from a number of different alphabets or scripts (e.g., Serbian, Bosnian, Kazakh, etc.)

Translation server 271 includes receipt translation module 272. Translation server 271 can be commonly owned along with POS system 211 and receipt data server 221. Alternately, translation server 271 can be owned by a 3^{rd} party. Translation module 272 can be specifically configured to translate text between written languages. Translation module 272 can be configured to translate digital receipt from and/or to virtually any written language, including but not limited to the previously described written languages. In some embodiments, receipt data server 221 refers to translation server 271 to have a digital receipt translated from one written language to another written language.

Mobile device 201 (e.g., a smartphone) includes communication module 203, display 204, and receipt management module 206. Generally, receipt management module 206 is configured to manage receipt data for a user of mobile device 201. Receipt management module 206 can be used to perform receipt related operations, such as, for example, sorting receipt data, searching receipt data, itemizing receipt data, translating receipt data, etc. in response to user-entered commands. Receipt management module 206 is also associated with application ID 231. Application ID 231 can be a unique ID used to distinguish receipt management module 206 (and thus also mobile device 201) from other receipt management modules (and thus also from other mobile devices). Application ID 231 can be assigned to mobile device 201 or derived from user related information, such as, for example, a telephone number, a loyalty card number, etc.

Receipt management module 206 can present user-interface 219 at display 204 (e.g., a general purpose display device). User-interface 206 can include (e.g., touch screen) user-interface controls allowing a user to select language settings. Selected language settings can be stored in language settings 232. Selected language settings can be used by receipt management module 206 to request digital receipts in a specified written language. For example, customer 291 can enter input 292 to request digital receipts in a specified written language, such as, Spanish, German, Japanese, Russian, Mandarin, etc. Thus, a user request for digital receipts in a specified written language can be accomplished by selecting language settings through user interface 291.

In some embodiments, portions of language settings 232 can be stored in receipt delivery preferences (possibly along with other receipt preferences) at receipt data server 221. At receipt data server 221, the receipt delivery preferences can be associated with application ID 231 to indicate that the receipt delivery preferences apply to mobile device 201. As such, receipt data server 221 can refer to stored portions of language settings 232 when a request for digital receipts is received from mobile device 201.

Accordingly, when appropriate and in response to accessed language settings (either stored at receipt data server 221 or included in a receipt request), receipt data server 221 can handle translating a digital receipt from one written language to another written language.

Communication module 203 can be a wireless network adapter for connecting mobile device 201 with a wireless network, such as, for example, Wi-Fi and/or a cellular network (e.g., CDMA, GSM, iDen, etc.) that facilitates a further connection to network 251 (e.g., the Internet)

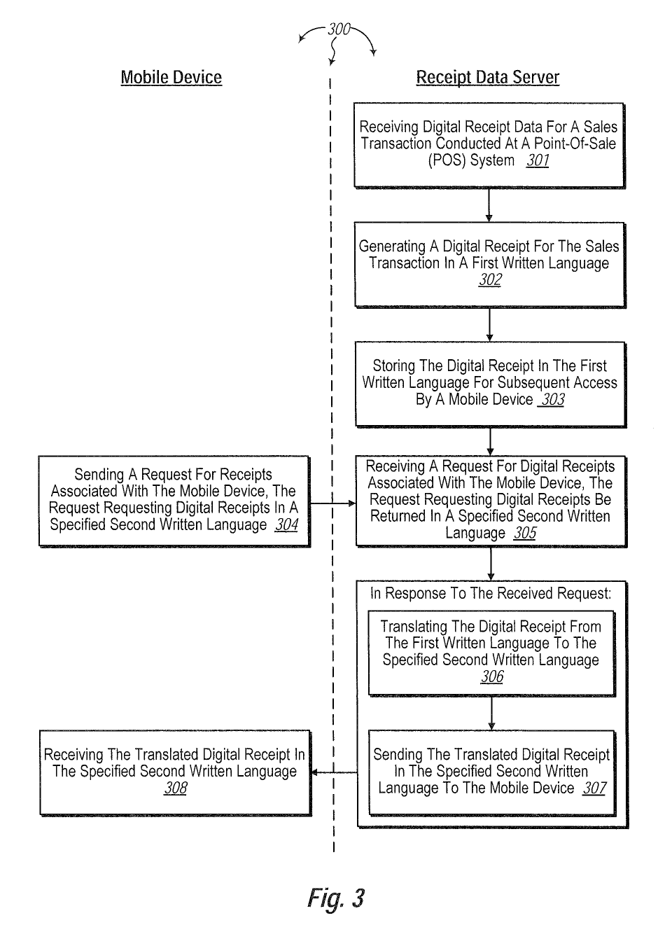

FIG. 3 illustrates a flow chart of an example method 300 for translating digital receipts between written languages. Method 300 will be described with respect to the components and data of computer architecture 200.

Method 300 includes receiving digital receipt data for a sales transaction conducted at a Point-Of-Sale (POS) system (301). For example, receipt data server 221 can receive application ID 231 and digital receipt data 261 from PSO system 211. Digital receipt data 261 can correspond to a sales transaction conducted at POS system 211. Digital receipt data 261 can be received along with application ID 231 to indicate that digital receipt data 261 corresponds to mobile device 201.

Method 300 includes generating a digital receipt for the sales transaction in a first written language (302). For example, receipt data server 221 can process digital receipt data 261 to generate digital receipt 233 for the sales transaction at POS system 211. In some embodiments, digital receipt 233 is generated in a default written language based on the geographic location of POS system 211. For example, if POS system 211 is physically located in the United States, receipt data server 221 can generate digital receipt 233 in English. In other embodiments, data receipt server 221 refers to stored language settings to determine a user-specified written language for a digital receipt. For example, customer 291 may have selected Japanese for a written language. The selection of Japanese can stored at receipt data server 221. Thus, receipt data server 221 can generate digital receipt 233 in Japanese.

Method 300 includes storing the digital receipt in the first written language for subsequent access by a mobile device (303). For example, database access module 263 can store digital receipt 233 along with application ID 231 in receipt database 222. Digital receipt 233 can be stored in a default written language based on geographic location or in a user-specified written language.

Method 300 includes sending a request for receipts associated with the mobile device, the request requesting digital receipts in a specified second written language (304). For example, mobile device 201 can send request 239, containing application ID 231, to receipt data server 221. Request 239 requests any digital receipts associated with mobile device 201. In some embodiments, request 239 expressly requests that digital receipts be returned to mobile device 201 in a written language other than the written language in which the digital receipts are stored.

Method 300 includes receiving a request for digital receipts associated with the mobile device, the request requesting digital receipts be returned in a specified second written language (305). For example, receipt data server 221 can receive request 239, containing application ID 231, from mobile device 201. As described, in some embodiments, request 239 expressly indicates that digital receipts be returned to mobile device 201 in a written language other than the written language in which the digital receipts are stored. In other embodiments, receipt data server refers to stored receipt data preferences for mobile device 201 to determine a written language to use when returning digital receipts to mobile device 201. Either from an express indication in request 239 or by reference to previously configured receipt preferences for mobile device 201, receipt data server 221 can determine that digital receipt 233 is to be translated into a written language other the written language in which digital receipt 233 is stored.

Method 300 includes, in response to the received request, translating the digital receipt from the first written language to the specified second written language (306). For example, in response to request 239, receipt data server 221 can handle translating digital receipt 233 from one written language to another written language. In some embodiments, receipt translation module 223 translates digital receipt 233 (e.g., in English) to translated digital receipt 233T (e.g., in Spanish). In other embodiments, receipt data server 221 sends digital receipt 233 to translation server 271. In these other embodiments, receipt translation module 272 translates digital receipt 233 into translated digital receipt 233T. Translation server 271 can then return translated digital receipt 233T back to receipt data server 221. Alternately or in combination, translation server 271 can also return translated digital receipt 233T to mobile device 201.

Translating a digital receipt can include translating items within the digital receipt from the first written language to the specified second written language. For example, data receipt server 221 can handle translating items 234A, 234B, and 234C, etc. (e.g., in English) to items 234AT, 234BT, 234T, etc. (e.g., in Spanish) respectively.

Method 300 includes, also in response to the received request, sending the translated digital receipt in the specified second written language to the mobile device (307). For example, receipt data server 221 can send translated digital receipt 233T to mobile device 201.

In some embodiments, receipt data server 221 stores translated digital receipt 233T for subsequent access.

Method 300 includes receiving the translated digital receipt in the specified second written language (308). For example, mobile device 201 can receive translated digital receipt 233T from receipt data server 221. Alternately or in combination, mobile device 201 can receive translated digital receipt 233T from translation server 271. Receipt management module 206 can present translated digital receipt 233T at user interface 219.

A mobile device can store digital receipts locally in multiple different languages, including an original language as well as one or more translations. When a digital receipt is stored in multiple languages, users can switch between various translations of the digital receipt more efficiently. For example, mobile device 201 can store digital receipt 233 and digital receipt 233T locally. Thus, if a switch from digital receipt 233 to digital receipt 233T or vice versa is requested, the switch can be implemented more efficiently.

In some embodiments, a message can be appended to a translated digital receipt to provide information related to the translation. An appended message can indicate that the translated digital receipt is provided as a convenience and that the digital receipt in the original written language is valid for tax purposes. For example, a message can be appended to digital receipt 233T. The message can indicated that digital receipt 233T is provided as a convenience and that the digital receipt 233 is valid for tax purposes.

In some embodiments, language/locale settings of a mobile device can be used to offer a translation feature. For example, when it is detected that a mobile device is in a location that uses a written language different from a selected written language in language/locale settings, the mobile device can activate and/or turn on a receipt translation feature. When using the receipt translation feature, a digital receipt can be provided to the mobile device in the original written language (i.e., the written language used at the location). The digital receipt can also be translated from the original written language into the selected written language and provided to the mobile device in the selected written language. For example, when a receipt translation feature is active at mobile device 201, both digital receipt 233 and translated digital receipt 233T can be provided to mobile device 201. Thus, as described, when a switch from digital receipt 233 to digital receipt 233T or vice versa is requested, the switch can be implemented more efficiently.

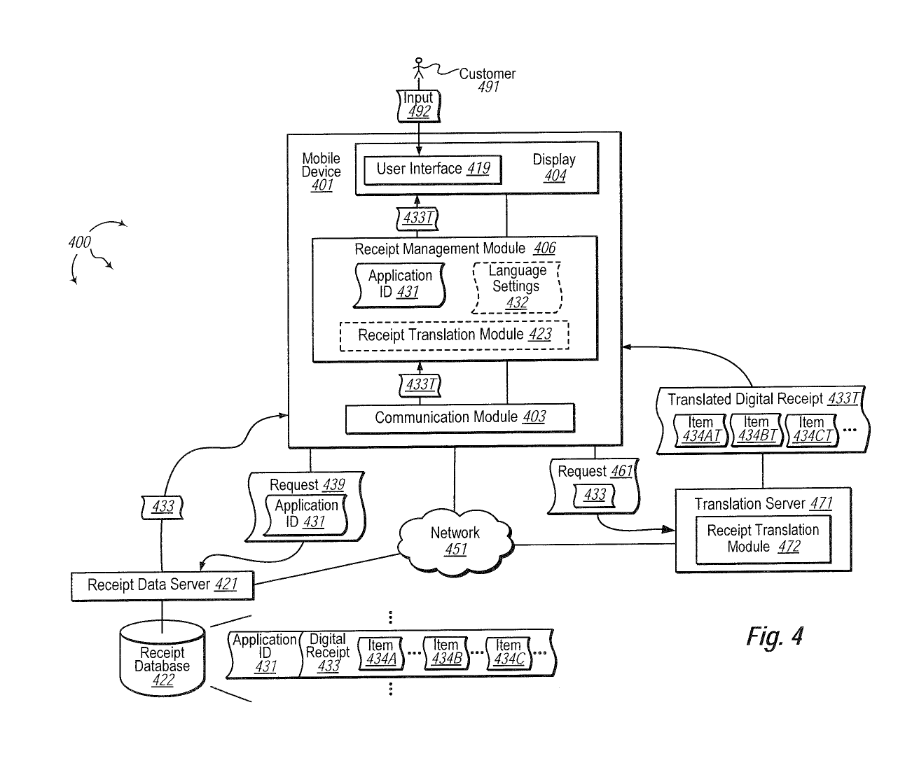

FIG. 4 illustrates an example computer architecture 400 that facilitates translating digital receipts between written languages. Referring to FIG. 4, computer architecture 400 includes mobile device 401, receipt data server 421, and translation server 471. Each of the depicted systems, servers, and devices as well as their respective components can be connected to one another over (or be part of) network 451, such as, for example, a PAN, a LAN, a WAN, and even the Internet. Accordingly, each of the depicted components as well as any other connected computer systems and their components, can create message related data and exchange message related data (e.g., near field communications (NFC) payloads, Bluetooth packets, Internet Protocol (IP) datagrams and other higher layer protocols that utilize IP datagrams, such as, Transmission Control Protocol (TCP), Hypertext Transfer Protocol (HTTP), Simple Mail Transfer Protocol (SMTP), etc.) over the network.

Receipt data server 421 can be configured similarly receipt data server 221. For example, receipt data server 421 can include a Web server, a communication module, and a database access module. As such, receipt data server 421 can receive receipt digital receipt data from POS systems (e.g., at one or more physical store locations) and formulate corresponding digital receipts. Receipt data server can store formulated digital receipts along with application IDs in receipt database 422. For example, receipt data server 421 can formulate digital receipt 433 including items 434A, 434B, 434C, etc. Receipt data server 421 can store digital receipt 433 along with application ID 321 in receipt database 422.

In some embodiments, receipt data server 421 is part of a (e.g., regional, national, or global) backend system that receives receipt data from a plurality of POS systems distributed throughout different geographic locations and formulates corresponding digital receipts. The plurality of POS systems and the backend system can be part of a commonly owned and/or controlled corporate network infrastructure.

Subsequent to storing digital receipts, receipt data server 421 can send stored digital receipts to customer computing devices, such as, for example, smartphones and/or tablets. Receipt data server 421 can send digital receipts to a mobile device in response to a request and/or in accordance with configured settings. For example, in response to a request for receipts from mobile device 401, receipt data server 421 can send digital receipt 433 to mobile device 401. Sending digital receipts from receipt data server 421 to a mobile device can involve push or polled mechanisms. Receipt data server 421 can send digital receipts in a web or native view.

Mobile device 401 (e.g., a smartphone) includes communication module 403, display 404, and receipt management module 406. Generally, receipt management module 406 is configured to manage receipt data for a user of mobile device 401. Receipt management module 406 can be used to perform receipt related operations, such as, for example, sorting receipt data, searching receipt data, itemizing receipt data, translating receipt data, etc. in response to user-entered commands. Receipt management module 406 is also associated with application ID 431. Application ID 431 can be a unique ID used to distinguish receipt management module 406 (and thus also mobile device 401) from other receipt management modules (and thus also from other mobile devices). Application ID 431 can be assigned to mobile device 401 or derived from user related information, such as, for example, a telephone number, a loyalty card number, etc.

Receipt management module 406 can present user-interface 419 at display 404 (e.g., a general purpose display device). User-interface 406 can include (e.g., touch screen) user-interface controls allowing a user to select language settings. Selected language settings can be stored in language settings 432. Selected language settings can be used by receipt management module 406 to request digital receipts in a specified written language. For example, customer 491 can enter input 492 to request digital receipts in a specified written language, such as, Italian, French, Korean, Greek, etc. Thus, a user request for digital receipts in a specified written language can be accomplished by selecting language settings through user interface 491.

Accordingly, when appropriate and in response to accessed language settings (either stored at mobile device 401 or included in user input), mobile device 401 can handle translating a digital receipt from one written language to another written language.

When appropriate, translation module 423 can translate a digital receipt from one written language to another written language. Translation module 423 can be configured to translate digital receipt from and/or to virtually any written language, including but not limited to: written languages that use variations of the Latin alphabet (e.g., written languages that use the English alphabet, the German Alphabet, the Czech alphabet, etc.), written languages that use variations of Cryllic script (e.g., written languages that use the Russian alphabet, etc.), written languages that use variations of Arabic script, Greek, written languages that use the Hebrew alphabet, written languages that use Chinese script (hanzi) (e.g., Mandarin), written languages that use Japanese script (kanji, hiragana, katakana), Korean, written languages that use the Devanagari alphabet (e.g., Hindi) as well as written languages that use characters or symbols from a number of different alphabets or scripts (e.g., Serbian, Bosnian, Kazakh, etc.)

Translation server 471 includes receipt translation module 472. Translation module 472 can be specifically configured to translate text between written languages. Translation module 472 can be configured to translate digital receipt from and/or to virtually any written language, including but not limited to the previously described written languages. In some embodiments, mobile device 401 refers to translation server 471 to have a digital receipt translated from one written language to another written language.

Communication module 403 can be a wireless network adapter for connecting mobile device 201 with a wireless network, such as, for example, Wi-Fi and/or a cellular network (e.g., CDMA, GSM, iDen, etc.) that facilitates a further connection to network 451 (e.g., the Internet)

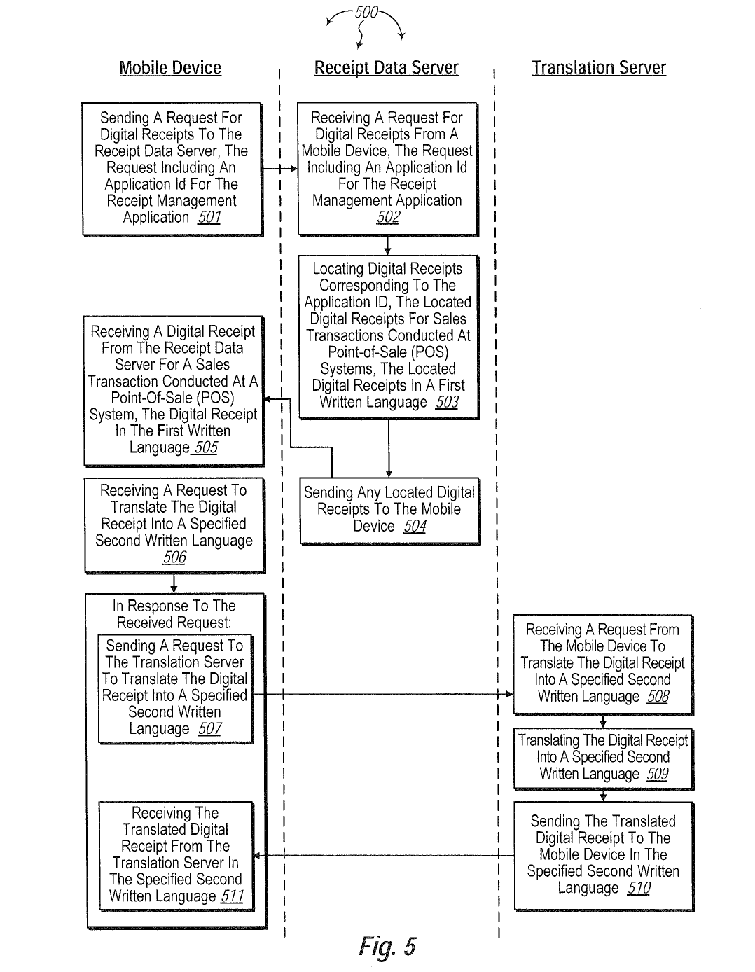

FIG. 5 illustrates a flow chart of an example method 500 for translating digital receipts between written languages. Method 500 will be described with respect to the components and data of computer architecture 400.

Method 500 includes sending a request for digital receipts to the receipt data server, the request including an application id for the receipt management application (501). For example, mobile device 401 can send request 439, containing application ID 431, to receipt data server 421. Request 439 requests any digital receipts associated with mobile device 401. Method 500 includes receiving a request for digital receipts from a mobile device, the request including an application ID for the receipt management application (502). For example, receipt data server 421 can receive request 439 from mobile device 401.

Method 500 includes locating any digital receipts corresponding to the application ID, the located digital receipts for sales transactions conducted at Point-Of-Sale (POS) systems, the located digital receipts in a first written language (503). For example, receipt data server 421 can locate digital receipt 433 corresponding to application ID 431. Digital receipt 433 can be for a sales transaction conducted at POS system by a user of mobile device 401. In some embodiments, digital receipt 433 is stored in a default written language based on the geographic location of a POS system where the sales transaction was conducted. For example, if the POS system is physically located in Mexico, receipt data server 421 can store digital receipt 433 in Spanish. In other embodiments, data receipt server 421 refers to stored language settings to determine a user-specified written language for a digital receipt. For example, customer 491 may have selected Hindi for a written language. The selection of Hindi can stored at receipt data server 421. Thus, receipt data server 411 can store digital receipt 433 in Hindi.

Method 500 includes sending any located digital receipts to the mobile device (504). For example, receipt data server 421 can send digital receipt 433 to mobile device 401. Method 500 includes receiving a digital receipt from a receipt data server for a sales transaction conducted at a Point-Of-Sale (POS) system, the digital receipt in the first written language (505). For example, mobile device 401 can receive digital receipt 433 from receipt data server 421.

Method 500 includes receiving a request to translate the digital receipt into a specified second written language (506). For example, receipt management application 403 can receive a request to translate digital receipt 433 into a different written language from customer 491. Customer 491 can submit input 492 at user interface 419. Input 492 can select a different written language for viewing digital receipt 433. User interface 419 can include user interface controls for selecting a written language for use in viewing a digital receipt. Alternately, receipt management application 403 can refer to language settings 432 to determine a different written language for viewing a digital receipt.

Method 500 includes, in response to receiving the request, sending a request to the translation server to translate the digital receipt into a specified second written language (507). For example, mobile device 401 can send request 461, containing digital receipt 433, to transaction server 471. Request 461 can indicate that digital receipt 433 is to be translated to the different written language. Method 500 includes receiving a request from the mobile device to translate the digital receipt into a specified second written language (508). For example, translation server 441 can receive request 463, containing digital receipt 433, from mobile device 401.

Method 500 includes translating the digital receipt into a specified second written language (509). For example, receipt translation module 472 can translate digital receipt 433 into translated digital receipt 433T. Translating digital receipt 433 can include translating items within digital receipt 433 to the different written language. For example, receipt translation module 472 can handle translating items 234A, 234B, and 234C, etc. (e.g., in Japanese) to items 234AT, 234BT, 234T, etc. (e.g., in French) respectively.

Method 500 includes sending the translated digital receipt to the mobile device in the specified second written language (510). For example, translation server 441 can send translated digital receipt 433T to mobile device 401. Method 500 includes, also in response to receiving the request, receiving the translated digital receipt from the translation server in the specified second written language (511). For example, network adapter 404 can receive translated digital receipt 433T from translation server 441.

In some embodiments, receipt translation module 423 translates digital receipt 433 (e.g., in Arabic) to translated digital receipt 433T (e.g., in English).

Translated digital receipt 433T can be presented on user interface 419 at display 404.

A mobile device can store digital receipts locally in multiple different languages, including an original language as well as one or more translations. When a digital receipt is stored in multiple languages, users can switch between various translations of the digital receipt more efficiently. For example, mobile device 401 can store digital receipt 433 and digital receipt 433T locally. Thus, if a switch from digital receipt 433 to digital receipt 433T or vice versa is requested, the switch can be implemented more efficiently.

In some embodiments, a message can be appended to a translated digital receipt to provide information related to the translation. An appended message can indicate that the translated digital receipt is provided as a convenience and that the digital receipt in the original written language is valid for tax purposes. For example, a message can be appended to digital receipt 433T. The message can indicated that digital receipt 433T is provided as a convenience and that the digital receipt 433 is valid for tax purposes.

In some embodiments, language/locale settings of a mobile device can be used to offer a translation feature. For example, when it is detected that a mobile device is in a location that uses a written language different from a selected written language in language/locale settings, the mobile device can activate and/or turn on a receipt translation feature. When using the receipt translation feature, a digital receipt can be provided to the mobile device in the original written language (i.e., the written language used at the location). The digital receipt can also be translated from the original written language into the selected written language and provided to the mobile device in the selected written language. For example, when a receipt translation feature is active at mobile device 401, both digital receipt 433 and translated digital receipt 433T can be provided to mobile device 401. Thus, as described, when a switch from digital receipt 433 to digital receipt 433T or vice versa is requested, the switch can be implemented more efficiently.

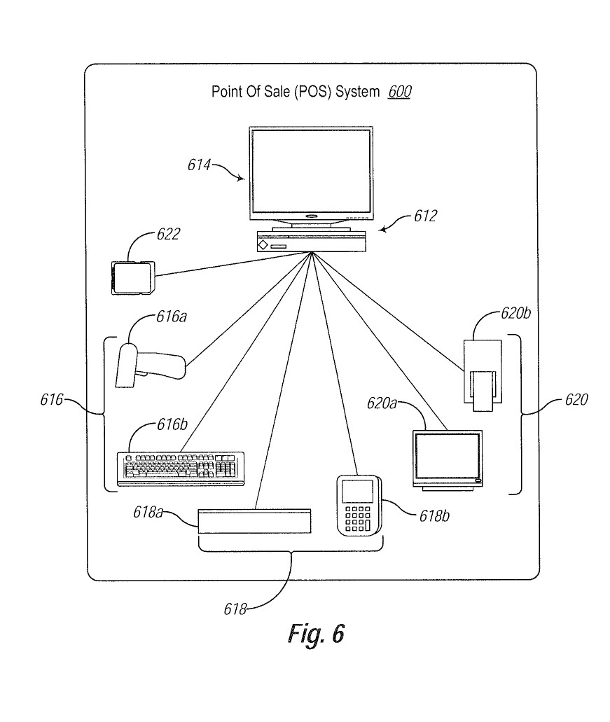

FIG. 6 illustrates an example schematic block diagram of a point-of-sale (POS) system 600. In some embodiments, the hardware, software, or hardware and software of POS system 600 may be configured to implement one or more methods in accordance with the present invention. For example, POS system 600 may be manufactured, programmed, modified, or upgraded to support transferring digital receipt data to mobile devices. Either of POS systems 211 and 411 can be a POS system similar to POS system 600.

POS system 600 can include various components. In some embodiments, POS system 600 includes a central or primary computer 612, a monitor 614 (e.g., a cashier-facing monitor 614), one or more input devices 616 (e.g., scanners 616a, keyboards 616b, scales, or the like), one or more payment devices 618 (e.g., cash drawers 618a, card readers 618b) for receiving or returning payments, one or more output devices 620 (e.g., customer-facing display 620a or monitor 620a, receipt printer 620b), or the like or combinations or sub-combinations thereof, and NFC module 622, such as, for example, an NFC dongle.

Computer 612 may form the backbone of POS system 610. Other components 616, 618, 620, 622 forming part of a POS system 610 can communicate with computer 612. Input devices 616 and certain payment devices 618 can feed data and commands to computer 612 for processing or implementation. For example, scanner 616a can pass data communicating the identity of one or more items to be purchased, returned, or the like to a computer 612. Similarly, card reader 618b can pass payment information to computer 612.

On the other hand, output devices 620 and certain payment devices 618 can follow or implement commands issued by computer 612. For example, cash drawer 618a may open in accordance with the commands of computer 612. Similarly, customer-facing display 620a and receipt printer 620b can display or output data or information as instructed by computer 612.

In some embodiments, in addition to handling consumer transactions (e.g., purchases, returns), POS system 600 can provide or support certain “back office” functionality. For example, POS system 600 can provide or support inventory control, purchasing, receiving and transferring products, or the like. POS system 600 can also store sales and customer information for reporting purposes, marketing purposes, receivables management, trend analysis, cost analysis, price analysis, profit analysis, or the like. If desired or necessary, POS system 1000 can include an accounting interface to pass certain information to one or more in-house or independent accounting applications.

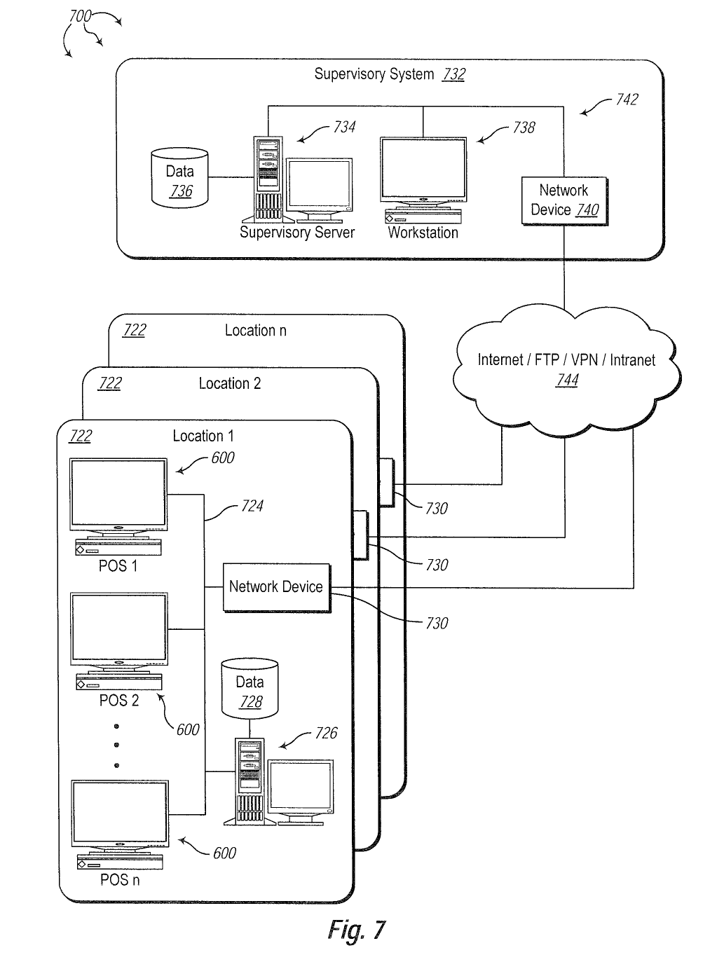

In some embodiments, POS system 600 operates substantially independently, as a stand-alone unit. Alternately, POS system 600 may be one of several POS systems 600 forming the front line of a larger system. FIG. 7 illustrates an example schematic block diagram of a network 700 of point-of-sale (POS) systems 1000. For example, multiple POS systems 1000 may operate at a particular location 722 (e.g., within a retail, brick-and-mortar store). In such embodiments, the various POS systems 600 may be interconnected via LAN 724. LAN 724 may also connect the POS systems 700 to a local server 726.

Local server 726 can support the operation of the associated POS systems 600. For example, a server 726 may provide a central repository from which certain data needed by the associated POS systems 600 may be stored, indexed, accessed, or the like. Server 726 can serve certain software to one or more POS systems 600. In certain embodiments, a POS system 600 can offload certain tasks, computations, verifications, or the like to server 726.

Alternatively, or in addition thereto, server 726 can support certain back office functionality. For example, server 726 can receive and compile (e.g., within an associated database 728) data from the various associated POS systems 600 to provide or support inventory control, purchasing, receiving and transferring products, or the like. Server 726 can also receive and compile sales and customer information for reporting purposes, marketing purposes, receivables management, trend analysis, cost analysis, price analysis, profit analysis, or the like.

In some embodiments, one or more POS systems 600 and/or servers 726 corresponding to a particular location 722 can communicate with or access one or more remote computers or resources via one or more network devices 730. For example, a network device 730 can enable a POS system 600 to contact outside resources and verify the payment credentials (e.g., credit card information) provided by a customer. A network device 730 can comprise a modem, router, or the like.

In selected embodiments, POS systems 600 operate within an enterprise-wide system 731 comprising multiple locations 722 (e.g., branches 722 or stores 722). In such embodiments, each location 722 may have one or more POS systems 600, local servers 726, local databases 728, network devices 730, or the like or combinations or sub-combinations thereof connected by a computer network (e.g., a LAN 724). It may be that any of data receipt servers 221 and 421 are included in and/or include the functionality of a local server 726.

Additionally, each such location 722 may be configured to interact with one or more supervisory systems 732. For example, multiple branch locations 722 may report to an associated “headquarters” location or system. It may be that any of data receipt servers 221 and 421 are included in and/or include the functionality of a supervisory system 732.

A supervisory system 732 can include one or more supervisory servers 734, databases 736, workstations 738, network devices 740, or the like or combinations or sub-combinations thereof. The various components of a supervisory system 732 can be interconnected via a computer network (e.g., a LAN 742). In selected embodiments, a supervisory system 732 includes one or more supervisory servers 734 providing a central repository from which certain data needed by the one or more POS systems 700 or local servers 726 may be stored, indexed, accessed, or the like.

Alternatively, or in addition thereto, a supervisory server 734 can receive and compile (e.g., within an associated database 736) data from the various associated POS systems 600 or local servers 726 to provide or support inventory control, purchasing, receiving and transferring products, or the like. A supervisory server 734 may also receive and compile sales and customer information for reporting purposes, marketing purposes, receivables management, trend analysis, cost analysis, price analysis, profit analysis, or the like.

A supervisory system 732 can be connected to one or more associated locations 722 or branches 722 in via any suitable computer network 744 (e.g., WAN 744). For example, in selected embodiments, one or more locations 722 can connect to a supervisor system 732 via the Internet. Communication over such a network 744 can follow any suitable protocol or security scheme. For example, communication may utilize the File Transfer Protocol (FTP), a virtual private network (VPN), intranet, or the like.

Although the components and modules illustrated herein are shown and described in a particular arrangement, the arrangement of components and modules may be altered to process data in a different manner. In other embodiments, one or more additional components or modules may be added to the described systems, and one or more components or modules may be removed from the described systems. Alternate embodiments may combine two or more of the described components or modules into a single component or module.

The foregoing description has been presented for the purposes of illustration and description. It is not intended to be exhaustive or to limit the invention to the precise form disclosed. Many modifications and variations are possible in light of the above teaching. Further, it should be noted that any or all of the aforementioned alternate embodiments may be used in any combination desired to form additional hybrid embodiments of the invention.

Further, although specific embodiments of the invention have been described and illustrated, the invention is not to be limited to the specific forms or arrangements of parts so described and illustrated. The scope of the invention is to be defined by the claims appended hereto, any future claims submitted here and in different applications, and their equivalents.

What is claimed:

1. At a receipt data server for a merchant, the receipt data server including one or more processors and system memory, the receipt data server connected to one or more Point-Of-Sale (POS) systems at each of one or more store locations for the merchant, the receipt data server configured to manage a receipt data for the merchant, a method for transferring translated digital receipt data to a mobile device, the method comprising:
receiving digital receipt data for a sales transaction conducted at a Point-Of-Sale (POS) system, the Point-Of-Sale (POS) system at a store location selected from among the one or more store locations, the digital receipt data containing a receipt entry for each of one or more items purchased by a customer in the sales transaction;
generating a digital receipt for the sales transaction in a first written language, the digital receipt generated from the digital receipt data, the digital receipt providing proof of the sales transaction, the digital receipt for delivery to a mobile device associated with the customer;
storing the digital receipt in the first written language for subsequent access by a mobile device;
receiving a request from a mobile device for digital receipts associated with the mobile device, the request requesting digital receipts be returned in a specified second written language;
in response to the received request, translating the digital receipt from the first written language to the specified second written language; and
sending the translated digital receipt in the specified second written language to the mobile device.

2. The method of claim 1, wherein receiving a request for a digital receipt comprises receiving a request from a receipt management application resident at a mobile device.

3. The method of claim 1, wherein receiving a request for digital receipts comprises receiving a request for digital receipts that expressly indicates that the digital receipts are to be returned in the specified second written language.

4. The method of claim 1, further comprising, prior to receiving the request, receiving specified language settings for the mobile device, the specified language settings indicating digital receipts are to be sent to the mobile device in the specified second written language.

5. The method of claim 4, further comprising referring to the specified language settings for the mobile device to determine that the digital receipt is to be translated into the specified second written language.

6. The method of claim 1, wherein receiving the request for digital receipts comprises receiving a request that includes a unique customer identifier corresponding to the mobile device.

7. The method of claim 1, further comprising sending the digital receipt to the mobile device in the first written language.

8. The method of claim 1, wherein translating the receipt from the first written language to the second specified written language comprises a translation module at the receipt data server translating the receipt from the first written language to the second specified written language.

9. The method of claim 1, wherein translating the receipt from the first written language to the second specified written language comprises;
sending the digital receipt in the first written language to a translation server; and
receiving the digital receipt back from the translation server in the specified second written language.

10. At a mobile device for a customer, the mobile device including one or more processors and system memory, the mobile device containing a receipt management application, the receipt management application configured to store and manage digital receipts for the customer, the mobile device able to communicate with a receipt data server, a method for translating a digital receipt, the method comprising:
sending a request for digital receipts to the receipt data server, the request including an application id for the receipt management application.
receiving a digital receipt from the receipt data server for a sales transaction conducted at a Point-Of-Sale (POS) system, the digital receipt containing a receipt item for each of one or more items purchased by a customer in the sales transaction, the digital receipt in a first written language;
receiving a request to translate the digital receipt into a specified second written language; and
in response to receiving the request, translating the digital receipt from the first written language into the specified second written language.

11. The method of claim 10, wherein sending a request for a digital receipt comprises sending a request for a digital receipt resident at a receipt data server.

12. The method of claim 10, wherein sending a request for digital receipts comprises sending a request for digital receipts that expressly indicates that the digital receipts are to be in the specified second written language.

13. The method of claim 10, further comprising, prior to sending the request, setting specified language settings in the receipt management application resident on the mobile device, the specified language settings indicating digital receipts are to be translated in the specified second written language for viewing at the mobile device.

14. The method of claim 13, further comprising referring to the specified language settings in the receipt management application to determine that the digital receipt is to be translated into the specified second written language.

15. The method of claim 10, wherein sending a request for digital receipts comprises sending a request that includes a unique customer identifier corresponding to the receipt management application resident on the mobile device.

16. The method of claim 10, wherein translating the receipt from the first written language to the second specified written language comprises a translation module resident on the mobile device translating the receipt from the first written language to the second specified written language.

17. The method of claim 10, wherein translating the receipt from the first written language to the second specified written language comprises:
sending the digital receipt to a translation server along with an indication that the digital receipt is to be translated into the specified second written language; and
receiving the digital receipt in the specified second written language from the translation server.

18. The method of claim 10, wherein translating the receipt from the first written language to the second specified written language comprises translating the receipt from the first written language to the second written language at the mobile device.

19. A system for translating digital receipt data from a first written language to a specified second written language, the system comprising: a mobile device and a receipt data server,
the mobile device comprising:
one or more processors;
system memory;
a network adapter;
one or more computer storage media having stored thereon computer-executable instructions that, when executed, cause the mobile device to:
send a request for digital receipts to the receipt data server, the request including an application id for the receipt management application, the request indicating that digital receipts are to be returned in a second specified language;
receive a digital receipt from the receipt data server for a sales transaction conducted at a Point-Of-Sale (POS) system, the digital receipt containing a receipt item for each of one or more items purchased by a customer in the sales transaction, the digital receipt in a second written language; and
display the digital receipt in the specified second written language at a display device; and
the data receipt server comprising:
one or more processors;
system memory;
a network adapter;
one or more computer storage media having stored thereon computer-executable instructions that, when executed, cause the data receipt server to:
store the digital receipts in a first written language for subsequent access by a mobile device;
receive the request from the mobile device;
in response to the received request, locate any digital receipts corresponding to the mobile device base on the application id;
translate located digital receipts from the first written language to the specified second written language; and
send the translated digital receipts in the specified second written language to the mobile device.

20. The system of claim 19, further comprising computer executable instructions that, when executed, cause the receipt data server to refer to language settings for the mobile device to determine that digital receipts are to be returned to the mobile device in the second written language.
